(19) United States
(12) Patent Application Publication
(10) Pub. No.: US 2013/0248276 A1
(43) Pub. Date: Sep. 26, 2013

(54) Magnetic Brake for Machine Steering Feedback

(71) Applicants: Mathew Chacko, Dunlap, IL (US); Douglas Husted, Eureka, IL (US); David Ober, Peoria, IL (US); Todd Smith, Peoria, IL (US); Lonny Johnson, Peoria, IL (US); Sabri Cetinkunt, West Chicago, IL (US); Shawn Cullen, Metamora, IL (US); Wendell Stahl, Bradford, IL (US)

(72) Inventors: Mathew Chacko, Dunlap, IL (US); Douglas Husted, Eureka, IL (US); David Ober, Peoria, IL (US); Todd Smith, Peoria, IL (US); Lonny Johnson, Peoria, IL (US); Sabri Cetinkunt, West Chicago, IL (US); Shawn Cullen, Metamora, IL (US); Wendell Stahl, Bradford, IL (US)

(73) Assignee: CATERPILLAR, INC., Peoria, IL (US)

(21) Appl. No.: 13/425,113

(22) Filed: Mar. 20, 2012

(51) Int. Cl. B60K 26/00; G08B 6/00

(52) U.S. Cl. 180/334; 340/438

(57) ABSTRACT

Resistance feedback is provided to a machine operator via a joystick configured to steer the machine. An electrically actuated magnetic feedback brake unit is associated with the joystick for selectively resisting movement of the joystick. Haptic feedback is provided by determining a machine speed at which the machine is travelling, mapping the determined machine speed to a corresponding joystick resistance value, and mapping the corresponding joystick resistance value to an actuation current. The electrically actuated magnetic feedback brake unit is then actuated at a current substantially exceeding the actuation current until a predetermined level of actuation is reached. Once the predetermined level of actuation is reached, the electrically actuated magnetic feedback brake unit is driven at the actuation current.

### TECHNICAL FIELD

This patent disclosure relates generally to haptic joysticks and, more particularly to a system for reducing response time in providing magnetic rheological or particle brake feedback to a user of a haptic joystick for steering a machine.

### BACKGROUND

Although automation has become prevalent in many areas of industry, there are still a number of critical tasks that remain operator-controlled. An example of this is machine steering. For example, large driven machines used for construction and industrial manipulation, loading, and transport are most often operator-steered. Moreover, because human operators are fallible and may have varying degrees of training and familiarity with the machine being steered, a human operator may inadvertently over-steer a machine under certain conditions. For example, a steering excursion of 20 degrees may be required at low speed to execute a turn, but that same level of steering can represent a substantial over-steer for the same machine when travelling at higher speeds.

Although it is known to provide feedback to a vehicle operator through a steering wheel, such systems do not provide feedback usable for joystick-steered machines, nor do they provide real-time resistance to oversteer. For example, U.S. Pat. No. 7,280,046 entitled “Steering System With Haptic Driver Warning” describes a system wherein a haptic feedback device shakes a steering wheel of a vehicle in order to warn the user of an unsafe condition. However, in addition to being applicable only to steering wheels, this system does not warn the driver of oversteer nor does it provide any corrective resistance or feedback in the event of oversteer. Rather, for any condition that triggers a warning, the user must first notice the shaking of the wheel, then identify the condition that triggered the shaking, and finally manually correct the identified condition.

It will be appreciated that this background description has been created by the inventors to aid the reader, and is not to be taken as a reference to prior art nor as an indication that any of the indicated problems were themselves appreciated in the art.

### SUMMARY

In an embodiment, resistance feedback is provided to a machine operator via a joystick configured to steer the machine and having associated therewith an electrically actuated magnetic feedback brake unit for selectively resisting movement of the joystick. The feedback is provided by determining a machine speed at which the machine is travelling, mapping the determined machine speed to a corresponding joystick resistance value, and mapping the corresponding joystick resistance value to an actuation current. The electrically actuated magnetic feedback brake unit is then actuated at a current substantially exceeding the actuation current until a predetermined level of actuation is reached. Once the predetermined level of actuation is reached, the electrically actuated magnetic feedback brake unit is driven at the actuation current.

In another embodiment, a steerable machine includes one or more steerable ground-engaging elements, an operator-controlled joystick for steering the machine by steering the one or more steerable ground-engaging elements, and a magnetic brake associated with the joystick. A controller is configured to impose resistance to movement of the joystick as a function of a speed of the machine by overdriving the magnetic brake until a predetermined condition is met.

In yet another embodiment, a feedback controller for providing resistance to movement of a machine steering joystick via an electrically actuated magnetic feedback brake unit includes a digital processor and an interface to receive machine state data. The processor has associated therewith a nontransitory computer-readable medium, having thereon computer-executable instructions to provide resistance to movement of the machine steering joystick by determining a machine speed, mapping the determined machine speed to a corresponding joystick resistance value, mapping the corresponding joystick resistance value to an actuation current of the feedback brake unit, driving the feedback brake unit at a current substantially exceeding the actuation current until a predetermined level of actuation is reached, and then driving the electrically actuated magnetic feedback brake unit at the actuation current.

Other features and aspects of the disclosed principles will become apparent upon reading the specification in conjunction with the attached figures, a brief description of which appears immediately below.

### BRIEF DESCRIPTION OF THE DRAWINGS

FIG. 1 is a simplified modular schematic showing a mechanism for joystick control of a machine;

FIG. 2 is a combined cross-sectional view and control schematic including a detailed view of a feedback brake unit in accordance with an embodiment;

FIG. 3 is a reaction timing plot showing resistive torque supplied by a feedback brake unit as a function of time relative to a command start time;

FIG. 4 is a reaction timing plot showing resistive torque supplied by a feedback brake unit as a function of time relative to a command start time pursuant to an overdrive signal in accordance with an embodiment;

FIG. 5 is a flow chart showing an exemplary process for implementing overdrive control of a haptic joystick in accordance with an embodiment; and

FIG. 6 is a flow chart showing an alternative process for implementing overdrive control of a haptic joystick in accordance with an alternative embodiment.

### DETAILED DESCRIPTION

This disclosure relates to haptic feedback for machine steering, and specifically to providing a rapid response time relative to magnetic rheological and particle brakes providing resistance to movement of a steering joystick in a machine. Joystick steering of machines is convenient and reduces stress on machine operators. However, an unwanted result of the ease of use of such systems is that the machine operator may occasionally attempt to oversteer a machine due to inattention, inexperience, or other factors.

In order to apprise the operator that they are attempting to oversteer the machine, and to discourage or prevent the oversteer from occurring, the described system provides a speed-based resistance to movement of the joy-stick for movements outside of a predetermined range in an embodiment. Moreover, because oversteer commands and resultant machine path deviation can occur quickly, the described feedback system is designed to react rapidly, increasing the resistance from essentially zero to a predetermined target value within little more than a tenth of a second for example.

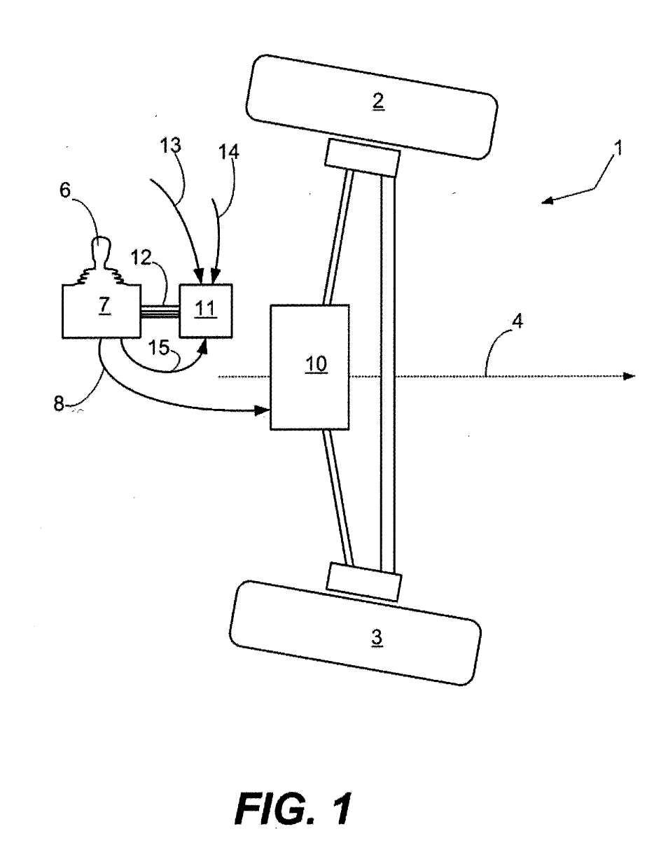

Turning to a more detailed discussion of an operating environment and exemplary principles of operation, FIG. 1 is a simplified modular schematic showing a mechanism for joystick control of a machine 1. The machine 1 as illustrated includes a plurality of wheels, two of which 2, 3 are shown, located at corner positions on the machine 1. A first wheel 2 and a second wheel 3 of the plurality of wheels are steerable relative to a machine axis 4 to direct the course of the machine 1 when the machine 1 is in motion. In an embodiment wherein the machine 1 is a track-type machine, the machine 1 may turn even when not in forward or reverse motion if zero radius turns are supported. The one or more wheels and or one or more tracks used to steer the machine are sometimes referred to herein as steerable ground-engaging elements.

Steering of the machine 1 is directed by an operator (not shown) via movement of a joystick 6 which is part of a joystick control unit 7. Movement of the joystick 6 is translated via encoding circuitry associated with the joystick control unit 7 into an electrical signal 8 related to the extent of movement of the joystick 6. For example, an excursion to the right by one half of the available stick travel in that direction (e.g., 20 degrees) may be translated into a signal having a voltage that is half of the output voltage range in the positive direction (e.g., 2.5V). Other systems for electrically encoding the joystick movement are usable in conjunction with the described principles as well, including proportional and non-proportional encoding systems, pulse width modulation, frequency modulation, and so on.

Once the input movement of the joystick 6 has been electrically encoded, the resultant electrical signal 8 is input to an actuator 10 for pivoting the first wheel 2 and second wheel 3, in a wheel-steered machine, by the indicated amount. The type of actuation is not critical, and the actuator 10 may be electrical or hydraulic, and may pivot the wheels via one or more push rods, gears, motors, etc. Although both the first wheel 2 and the second wheel 3 will typically be pivoted in response to a joystick command, it will be appreciated that the degree of pivot may not match for each wheel, as will be appreciated by those of skill in the art.

Although the illustrated configuration utilizes steerable wheels, it will be appreciated that other steering systems may be used instead. For example, the electrical signal 8 resulting from operator manipulation of the joystick 6 may be used instead to pivot a rear set of wheels or all wheels. Similarly, the electrical signal 8 resulting from operator manipulation of the joystick 6 may be used to provide steering via differential track speeds in a track type machine, or to pivot a front and back half of a machine relative to one another in another configuration.

The joystick control unit 7 is linked to a feedback brake unit 11 linked via shaft 12 to the joystick 6. The feedback brake unit 11 provides a variable resistance to movement to limit the movement of the joystick 6 based on a number of parameter signals such as a machine speed signal 13 and a displacement signal 15 (e.g., pure displacement, angular velocity, or error between joystick displacement and machine steering angle) based on the movement of the joystick 6.

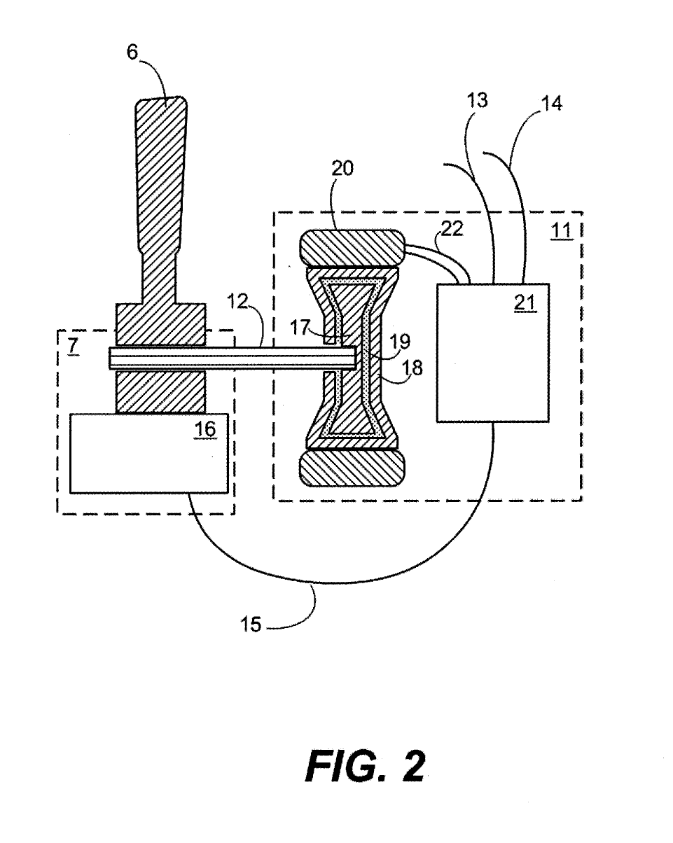

A generalized example structure for the feedback brake unit 11 is shown in greater detail in FIG. 2. In particular, FIG. 2 is a combined cross-sectional view and control schematic including a detailed view of the feedback brake unit 11. As noted above, the joystick 6 is linked to the feedback brake unit 11 via the shaft 12, such that lateral displacement of the joystick 6 serves to rotate the shaft 12 in addition to providing a displacement signal 15 via the joystick electronics 16.

The shaft 12 is in turn linked to a rotor 17 within a rotor housing 18. In this way, any movement of the joystick 6 rotates the rotor 17 within the rotor housing 18. In the illustrated example, the rotor housing 18 surrounds the rotor 17 and is filled with a magnetically reactive medium 19.

The magnetically reactive medium 19 may comprise for example a magnetic rheological medium or a magnetic particle medium. As will be appreciated by those of skill in the art, a magnetic rheological medium is a fluid containing particles or particulates that align to a controllable degree under the influence of an applied magnetic field to alter the macroscopic viscosity of the fluid. Similarly, in a dry magnetic powder, magnetic particles of appropriate size and composition will also react to an applied magnetic field to bind more or less strongly to one another, altering the resistance of the powder to flow and change.

Thus, in the illustrated example, application of a magnetic field to the magnetically reactive medium 19 serves to provide resistance to rotation of the rotor 17 in proportion to the applied field. Although a magnetic field may be generated, applied, and controlled in any of numerous ways, the illustrated embodiment of the feedback brake unit 11 includes an electromagnetic coil 20 circumferentially surrounding the rotor housing 18, and the rotor 17 and magnetically reactive medium 19 therein.

A feedback controller 21 within the feedback brake unit 11 receives signals indicative of machine state, e.g., the machine speed signal 13, and displacement signal 15, and responsively provides a current signal 22 to the electromagnetic coil 20. Other machine state parameters may also be received and utilized by the feedback controller, such as hydraulic oil temperature 14. As the resistance to movement of the rotor 17 increases due to the effect of the applied magnetic field on the magnetically reactive medium 19, the shaft 12 becomes more difficult to rotate, causing the joystick 6 to become more difficult to displace.

In this manner, displacement of the joystick 6 by the operator is made more or less difficult based on the machine state. Thus, for example, at high machine speeds, smaller displacements of the joystick are needed to avoid destabilizing the machine, e.g., to avoid excess roll (which in the worst case could result in machine roll-over) and excess yaw (which could result in skidding and loss of directional control). However, due to the rapidity with which an operator may be able to displace the joystick 6 and the swiftness with which the machine steering actuator 10 is able to respond, the feedback brake unit 11 should be configured to respond quickly in order to prevent over-control.

Countering this constraint, there are a number of sources of delay inherent in the control and response of the feedback brake unit 11. Generally speaking, these sources of delay can be categorized as processing delay and magnetic response delay. The processing delay is a result of the fact that the feedback controller 21 must process the received machine state signals and joystick motion signal, determine a signaling response for control of the electromagnetic coil 20, and output the requisite signaling response, i.e., to electrically energize the electromagnetic coil 20. Although processing delays such as these are necessarily present, the amount of time by which they hinder the feedback process is not significant.

In contrast, the other primary source of delay, i.e., magnetic response delay, can significantly lessen the responsiveness of the feedback brake unit 11 and render it ineffective for avoiding over-control. The magnetic response delay can be considered as originating from (1) the delay incurred while a ferrous core of the electromagnetic coil 20 builds a magnetic flux in response to the applied current signal and (2) the delay incurred while the magnetic portions of the magnetically reactive medium 19 align or otherwise react to the magnetic flux generated by the electromagnetic coil 20.

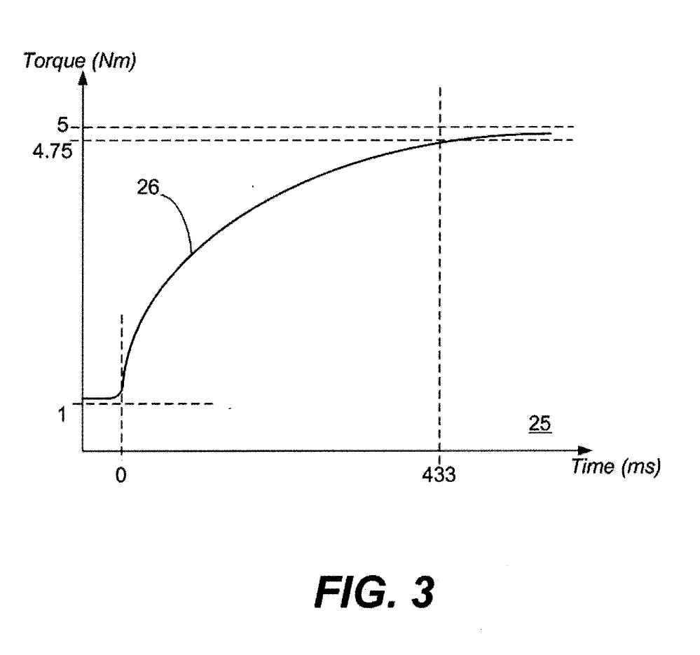

The combined effect of response delay can be seen in the simplified reaction timing plot 25 of FIG. 3. In particular, the vertical axis of FIG. 3 represents the resistive torque 25 supplied by the feedback brake unit 11 and the horizontal axis represents the time after which particular torque values are reached relative to a command start time. As can be seen, for a target resistance (reactive torque) of 5 Nm, the normal response curve 26 upon application of a current that would result in a steady state resistance of 5 Nm requires about 433 ms to reach 95% of the steady state resistance. This means that the desired resistance of 5 Nm would not be felt at the joystick until almost a half-second after the joystick displacement reaches a threshold beyond which 5 Nm of resistance is appropriate.

In order to enhance the response of the feedback brake unit 11, the feedback controller 21 or other controller implements an overdrive protocol such that the electromagnetic coil 20 is initially driven at or beyond its maximum rated capacity when a torque change is commanded. Although exceeding a maximum rated current for an extended period of time could damage the electromagnetic coil 20 due to heat build-up, a transient overdrive condition will typically not allow sufficient heat to build to cause damage.

Thus, for example, with respect to a feedback brake unit 11 having a maximum rated current of 10 amps, and which would provide a steady state resistance of 5 Nm at 3 amps, the feedback controller 21 may drive the electromagnetic coil 20 at or above 10 amps for an amount of time calculated or observed to yield a 95% change to the target value. After the initial overdrive period, the feedback controller 21 may lower the current to the electromagnetic coil 20 to the required steady state current, i.e., 3 amps in the given example.

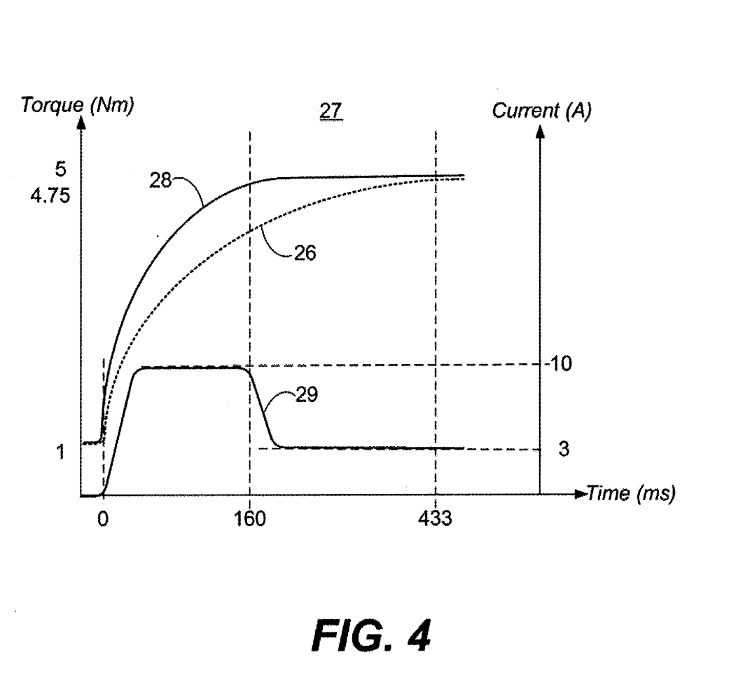

The resultant torque response 28 can be seen in the simplified response plot 27 of FIG. 4. In the illustrated example, based on the foregoing device specifications, the current 29 to the electromagnetic coil 20 is initially at 0 amps. At time t=0, a command to provide 5 Nm of resistance at a steady state current of 3 amps is received. The feedback controller 21 subsequently increases the current 29 to the electromagnetic coil 20 to the maximum of 10 amps, and maintains it at that level until the resultant torque 28 reaches 95% of the target value, i.e., 4.75 Nm. At that point, the current 29 to the electromagnetic coil 20 is decreased to the steady state value, e.g., 3 amps, until a further change in torque is commanded.

As can be seen, using the overdrive protocol described, the feedback controller 21 is able to provide the necessary torque response in about a third of the time previously required. In particular, with the overdrive protocol, the 95% torque point is reached in 160 ms, as compared to 433 ms to reach the same point otherwise. This same qualitative behavior is also available in the case of decreases in torque, although the enhancement is fractionally less significant for overdriving during commanded torque decreases. For example, it has been observed that in dropping the torque of the feedback brake unit 11 from 5 Nm down to its inherent unpowered torque of about 1 Nm, a step-wise drop in drive current from one level to the other results in a 95% transition time of about 560 ms. If an overdrive current is instead used to reach the 95% decrease point (e.g., by applying a coil current in an opposite direction at maximum magnitude), a shorter transition time of about 440 ms is observed.

### Industrial Applicability

The described principles are applicable to machines having joystick control of one or more functions wherein variable resistance, or haptic feedback, to the movement of the joystick is desired. One example of such an application environment is the joystick control of machine steering. For example, to avoid over steering of the machine by the operator, it is desirable to provide resistance to movement of the joystick beyond a certain displacement and/or as an increasing function of machine speed, wherein one or both of the resistance and the displacement for providing that resistance may be a function of machine speed and other parameters.

Thus, for example, while the operator may be able to displace the joystick in either direction to its full range when the machine is travelling slowly, the range of displacement over which the operator feels little resistance will contract as the machine speed increase. In this way, the operator is prevented from over-steering the machine and is also made aware that the attempted joystick movement would represent an impermissible over-steer.

In an embodiment, the overdrive control procedure is managed by the feedback controller 21 within the feedback brake unit 11 as described above. In this regard, the feedback controller 21 may be a computing device incorporating one or more microcontrollers and/or microprocessors (collectively referred to herein as the “processor” or “digital processor”). The processor operates by reading computer-executable instructions, or code, from a nontransitory computer-readable medium such as a nonvolatile memory, a magnetic or optical disc memory, a flash drive, and so on. It will be appreciated that data used by the processor in the execution of the computer-executable instructions may be stored and read out as well. The feedback controller 21 has one or more interfaces to receive machine state data, e.g., from an engine controller, temperature sensors, speed sensors, and so on.

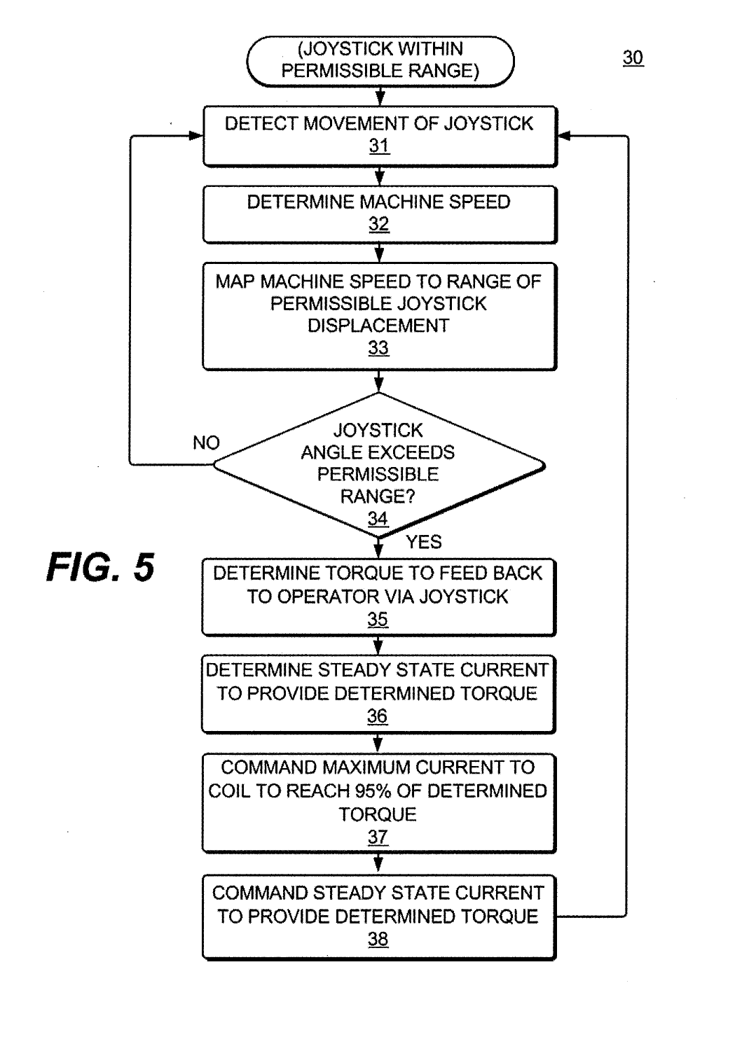

An exemplary process executable by the feedback controller 21 to implement the described overdrive control technique is shown in FIG. 5. The process 30 begins at stage 31 whereat the feedback controller 21 receives an indication that the joystick 6 has begun moving, i.e., the operator is inputting a steering command. In an embodiment, small unintentional movements of the joystick 6 are filtered out by only considering the joystick 6 to have moved if the degree of movement exceeds a predetermined threshold, e.g., 2 degrees.

Having determined that the joystick 6 has moved, the feedback controller 21 evaluates a state of the machine at stage 32, including for example, determining the machine speed over the ground. At stage 33, the feedback controller 21 maps the determined machine speed to a range of permissible steering angles, i.e., a range of permissible joystick displacement.

The feedback controller 21 determines at stage 34 whether the angle of the joystick 6 is within the range of permissible joystick displacement, and if the angle is within the range of permissible joystick displacement, the process 30 returns to stage 31 to await further movement of the joystick 6. If instead it is determined at stage 34 that the angle of the joystick 6 exceeds the range of permissible joystick displacement, the process continues to stage 35, wherein the feedback controller 21 determines a torque to feed back to the operator via the joystick 6.

At stage 36, the feedback controller 21 determines a steady state current required to provide the determined torque, and at stage 37 the feedback controller 21 commands a maximum current greater than the required current (e.g., an overdrive current) to the electromagnetic coil 20 surrounding the rotor housing 18 for a predetermined period or until a predetermined fraction of desired torque is reached, and then commands a current drop to the required current. Once the predetermined period has expired or the predetermined fraction of desired torque has been reached, the feedback controller 21 outputs a command to provide the determined steady state current required to yield the determined torque at stage 38 and returns to stage 31 to await further movement of the joystick 6.

In an embodiment, the predetermined period is the period empirically determined or calculated to result in is a rise in torque to about 95% of the required value. Thus, the predetermined period may be different for different required torque values, with the 95% period typically being longer for higher torques and shorter for lower torques. The predetermined period may also differ depending upon the torque value existing prior to the command to change to the newly determined torque value. For example, if the feedback controller 21 is already commanding a torque of 4 Nm, a transition to 5 Nm can be accomplished much more quickly than if the feedback controller 21 were previously commanding a torque of only 1 Nm. Thus, in a further embodiment, the predetermined period during which the overdrive current is to be applied is a function of the torque currently being maintained by the feedback controller 21 as well as the new required torque.

Although not yet discussed in detail, it will be appreciated that the technique of overdriving the electromagnetic coil 20 for a predetermined period of time applies not only to sudden increases in required torque but also to sudden decreases in required torque. For example, when the joystick 6 has been moved past the permissible range and a high feedback torque has been applied, the user will often subsequently return the joystick 6 to a position within the permissible range. In such a case, the applied feedback torque should quickly be reduced substantially, i.e., returned to its lowest steady state value, as the joystick 6 is returned to within the permissible range.

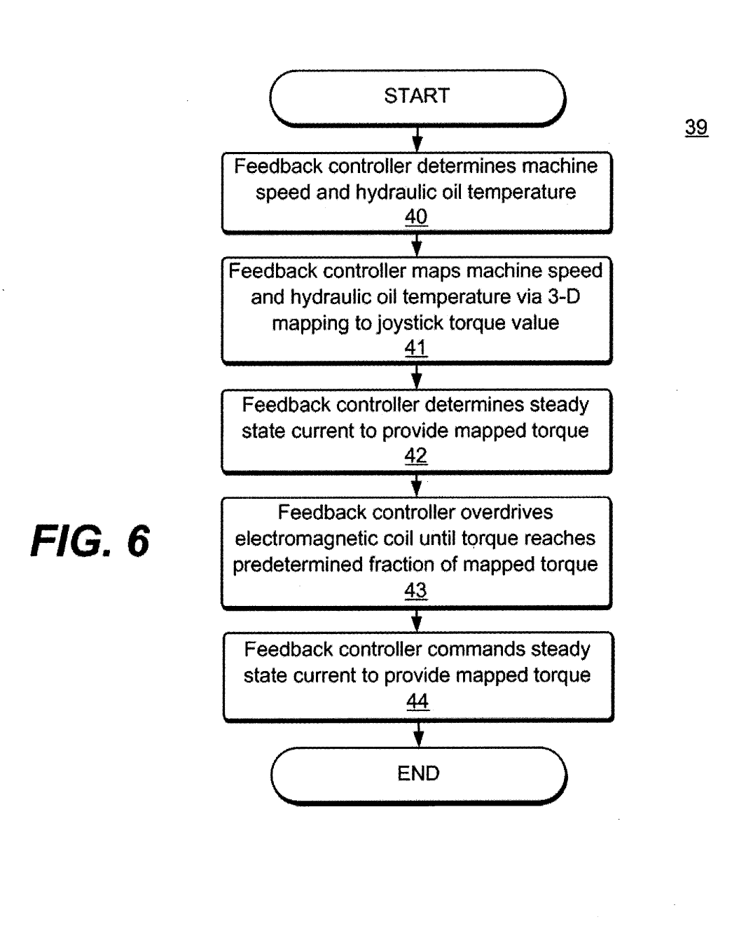

In an alternative embodiment, the resistance value or torque value to be provided to the machine operator via the joystick 6 is set based on machine speed and optionally hydraulic oil temperature in the machine hydraulic circuit. An example of this embodiment is shown in the flowchart of FIG. 6. In particular, at stage 40 of the process 39, the feedback controller 21 determines the machine speed and hydraulic oil temperature without regard to joystick angle. The feedback controller 21 then maps the determined machine speed and hydraulic oil temperature at stage 41 via a three-dimensional mapping to a joystick torque value.

At stage 42, the feedback controller 21 determines the steady state current that will provide the mapped torque when applied to the electromagnetic coil 20, and at stage 43 the feedback controller 21 commands an overdrive current to the electromagnetic coil 20 until the torque exerted by the joystick is a predetermined fraction, e.g., 95%, of the mapped torque. Once the torque exerted by the joystick 6 reaches the predetermined fraction of the mapped torque, the process 39 moves to stage 44, wherein the feedback controller 21 commands the determined steady state current required to provide the mapped torque. For each change in machine speed and/or hydraulic oil temperature, the process 39 may be repeated. In an embodiment, only changes greater than a predetermined tolerance are used to trigger a repetition of the process 39.

It will be appreciated that the foregoing description provides useful examples of the disclosed systems, apparatus, and techniques. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for the features of interest, but not to exclude such from the scope of the disclosure entirely unless otherwise specifically indicated.

What is claimed is:

1. A method of providing feedback to a machine operator via a joystick configured to steer the machine and having associated therewith an electrically actuated magnetic feedback brake unit for selectively resisting movement of the joystick, the method comprising:
determining a machine speed at which the machine is travelling;
mapping the determined machine speed to a corresponding joystick resistance value;
mapping the corresponding joystick resistance value to an actuation current;
driving the electrically actuated magnetic feedback brake unit at a current substantially exceeding the actuation current until a predetermined level of actuation is reached; and
after the predetermined level of actuation is reached, driving the electrically actuated magnetic feedback brake unit at the actuation current.

2. The method of providing feedback to a machine operator via a joystick configured to steer the machine in accordance with claim 1, wherein the step of determining a machine speed at which the machine is travelling further comprises determining a temperature of hydraulic oil within the machine, and wherein mapping the determined machine speed to a corresponding joystick resistance value comprises mapping the determined machine speed and determined hydraulic oil temperature to a corresponding joystick resistance value.

3. The method of providing feedback to a machine operator via a joystick configured to steer the machine in accordance with claim 1, further comprising determining a displacement of the joystick, wherein mapping the determined machine speed to a corresponding joystick resistance value comprises mapping the determined machine speed and joystick displacement to a corresponding joystick resistance value.

4. The method of providing feedback to a machine operator via a joystick configured to steer the machine in accordance with claim 1, wherein mapping the determined machine speed and joystick displacement to a corresponding joystick resistance value comprises:
mapping the determined machine speed to an allowed joystick displacement;
determining whether the joystick displacement exceeds the allowed joystick displacement; and
mapping the joystick displacement to a joystick resistance value when the joystick displacement exceeds the allowed joystick displacement.

5. The method of providing feedback to a machine operator via a joystick configured to steer the machine in accordance with claim 1, wherein the predetermined level of actuation is reached when a predetermine time has elapsed.

6. The method of providing feedback to a machine operator via a joystick configured to steer the machine in accordance with claim 1, wherein the predetermined level of actuation is reached when a predetermined fraction of the corresponding joystick resistance value has been reached.

7. The method of providing feedback to a machine operator via a joystick configured to steer the machine in accordance with claim 1, wherein the electrically actuated magnetic feedback brake unit comprises a magnetic rheological brake.

8. The method of providing feedback to a machine operator via a joystick configured to steer the machine in accordance with claim 1, wherein the electrically actuated magnetic feedback brake unit comprises a magnetic particle brake.

9. The method of providing feedback to a machine operator via a joystick configured to steer the machine in accordance with claim 1, wherein mapping the determined machine speed to a corresponding joystick resistance value further comprises determining an error value corresponding to an error between a steering angle of the machine and a displacement of the joystick, and mapping the determined machine speed and determined error value to a corresponding joystick resistance value.

10. The method of providing feedback to a machine operator via a joystick configured to steer the machine in accordance with claim 1, wherein mapping the determined machine speed to a corresponding joystick resistance value further comprises determining an angular velocity associated with displacement of the joystick, and mapping the determined machine speed and determined angular velocity to a corresponding joystick resistance value.

11. A steerable machine comprising:
one or more steerable ground-engaging elements;
an operator-controlled joystick for steering the machine by steering the one or more steerable ground-engaging elements;
a magnetic brake associated with the joystick; and
a controller configured to impose resistance to movement of the joystick via the magnetic brake as a function of a speed of the machine, wherein the controller imposes a target resistance by overdriving the magnetic brake until a predetermined condition is met.

12. The steerable machine in accordance with claim 11, wherein the function of the speed of the machine is further a function of a temperature of hydraulic oil within the machine,

13. The steerable machine in accordance with claim 11, wherein the function of the speed of the machine is further a function of a displacement of the joystick.

14. The steerable machine in accordance with claim 11, wherein the function of the speed of the machine and the displacement of the joystick increases with increased machine speed and with increased joystick displacement.

15. The steerable machine in accordance with claim 11, wherein the predetermined condition is when a predetermine time has elapsed.

16. The steerable machine in accordance with claim 11, wherein the predetermined condition is when a predetermined fraction of the target resistance has been attained.

17. The steerable machine in accordance with claim 11, wherein the magnetic brake associated with the joystick comprises a magnetic rheological brake.

18. The steerable machine in accordance with claim 11, wherein the magnetic brake associated with the joystick comprises a magnetic particle brake.

19. The steerable machine in accordance with claim 11, wherein the one or more steerable ground-engaging elements include at least one of a wheel and a track.

20. A feedback controller for providing resistance to movement of a machine steering joystick via an electrically actuated magnetic feedback brake unit, the feedback controller comprising:
a digital processor;
an interface to receive machine state data; and
a nontransitory computer-readable medium associated with the digital processor and having thereon computer-executable instructions to provide resistance to movement of the machine steering joystick by determining a machine speed, mapping the determined machine speed to a corresponding joystick resistance value, mapping the corresponding joystick resistance value to an actuation current of the feedback brake unit, driving the feedback brake unit at a current substantially exceeding the actuation current until a predetermined level of actuation is reached, and then driving the electrically actuated magnetic feedback brake unit at the actuation current.
